(19) United States
(12) Patent Application Publication
(10) Pub. No.: US 2022/0349437 A1
(43) Pub. Date: Nov. 3, 2022

(54) FASTENER AND METHOD OF MANUFACTURE THEREOF

(71) Applicant: COMMONWEALTH STEEL COMPANY PTY LTD, Sydney (AU)

(72) Inventors: Mark BUTTERFIELD, Bassendean (AU); Gareth O'NEIL, Sydney (AU); Bradford Shane MCCRACKEN, Sydney (AU)

(21) Appl. No.: 17/764,109

(22) PCT Filed: Sep. 24, 2020
(86) PCT No.: PCT/AU2020/051019

§ 371 Date: Mar. 25, 2022

(30) Foreign Application Priority Data
Sep. 26, 2019 (AU) 2019903637

(51) Int. Cl. F16B 35/06; F16B 35/04

(52) U.S. Cl. CPC F16B 35/06; F16B 35/048

(57) ABSTRACT

Aspects herein are generally directed to a fastener having a disco-rectangular cross-sectional shape. This shape is advantageous for purposes of gripping and as the disco-rectangular shape provides a gap between the edges of a countersunk bore and the edges of the disco-rectangular shape. As such, a user of the disco-rectangular shape may be able to grip the edges of the disco-rectangular shape, with fingers or any other type of tool.

### TECHNICAL FIELD

The present disclosure relates to a fastener and a die for fabrication of said fastener. In particular, the present disclosure relates to a fastener to secure a wear surface liner to a crusher or grinding mill, the fastener being specifically designed to permit improved seating of the fastener in a recess of a wear surface liner.

### BACKGROUND

The following discussion of the background to the disclosure is intended to facilitate an understanding of the present disclosure. However, it should be appreciated that the discussion is not an acknowledgement or admission that any of the material referred to was published, known or part of the common general knowledge as at the priority date of the application.

Grinding mills are used in the grinding of various ores in the mining industry. For example, a grinding mill can comprise a rotating drum containing steel grinding balls to impact and break up larger rock ores. The attrition between the grinding balls and the rock ore particles produces finer particles. During the grinding operation, an interior of the grinding mill drum is prone to wear. To prevent wear and to increase the life of the interior, the grinding mill drum is typically lined with a wear surface liner.

The wear surface liner is secured to the interior of the drum by fasteners inserted into non-circular countersunk through-hole bores in the liner, passing through a collocated bore in the grinding mill drum. The fasteners generally include a threaded shank and a non-circular head defining opposing load-bearing tapered surfaces corresponding to the taper of the countersunk bores in the liner. The fasteners are loaded by tightening a nut threaded onto the fastener shank extending beyond the exterior of the grinding mill drum.

In such applications, the fasteners are subject to cyclic loading and the heads may be poorly seated in the countersunk bore of the liner, causing the fastener to lose tension. This can lead to fatigue and failure of the fastener.

Traditionally fasteners are forged in a conventional two-part die. A seam, defined by the abutment of opposing parts of the die (i.e. the die split line), is created on opposing sides of the fastener. Typically, the two-part die is configured such that the seam extends along the shank and the tapered surfaces of the head.

After forging, the remnants of metal comprising the seam may be subsequently ground to create a smooth surface. The grinding process often subjects the tapered surfaces of the bolt to damage and unintentional (and uneven) alteration of the taper angle of the tapered surfaces. Consequently, the head may fail to seat correctly and not maintain sufficient surface area contact with the wear surface liner to remain ‘tight’. Additionally the incorrectly seated fasteners are subsequently subject to a higher rate of fatigue and may break or fracture with expensive consequences if the wear surface liner becomes detached.

The present disclosure seeks to address the problems to mitigate the potential of an incorrectly seated fastener, and improve on the forging process by preventing the creation of a seam along the load-bearing tapered surfaces of the fastener.

### SUMMARY

The present disclosure relates to a fastener to secure a wear surface liner to a crusher or grinding mill, a die for forging the fastener, a liner assembly, and a method of manufacturing a fastener.

Aspects herein are generally directed to a fastener comprising a head, the head having a constant cross-section portion and a tapered cross-section portion, wherein the constant cross-section portion and the tapered cross-section portion have a disco-rectangular cross-sectional shape. The disco-rectangular cross-sectional shape has a width, an overall length, and two parallel length portions. The fastener additionally comprises a non-threaded body portion, and a threaded body portion.

Further aspects herein are generally directed to a die configured to form a fastener, the die comprising a head recess, the head recess having a constant cross-section portion and a tapered cross-section portion, wherein the constant cross-section portion and the tapered cross-section portion have a disco-rectangular cross-sectional shape. The disco-rectangular cross-sectional shape has a height, an overall length, and two parallel length portions. The die additionally comprises a body recess, the body recess having a non-threaded body portion, and a threaded-body portion.

Further aspects herein are generally directed to a method of manufacturing a fastener, the method comprising providing a die, the die comprising a head recess, the head recess having a constant cross-section portion and a tapered cross-section portion, wherein the constant cross-section portion and the tapered cross-section portion have a disco-rectangular cross-sectional shape, the disco-rectangular cross-section shape having a height, an overall length, and two parallel length portions; and a body recess, the body recess having a non-threaded body portion, and a threaded-body portion.

In another aspect of the disclosure there is provided a fastener comprising a shank and an oblate non-circular-shaped head having a first axis xa and a second axis xb longer than and perpendicular to first axis xa, the fastener having a seam longitudinally aligned with the first axis xa extending along the shank and opposing sides of the head.

In yet another aspect of the disclosure there is provided a die configured for forging a fastener, the fastener comprising a shank and a non-circular-shaped head having a first axis xa and a second axis xb longer than and perpendicular to first axis xa, wherein the die is configured to provide a die split line longitudinally aligned with the first axis xa to produce the fastener with a correspondingly aligned seam extending along the shank and opposing sides of the head.

In yet another aspect of the disclosure there is provided a liner assembly comprising a liner having a non-circular-shaped recess, and a fastener comprising a shank and a non-circular-shaped head having a first axis xa and a second axis xb longer than and perpendicular to the first axis xa, the head being configured, in use, to mate with the recess so as to stop the fastener from rotating within the recess, wherein the fastener has a seam extending along the shank and opposing sides of the head which is aligned with the first axis xa.

In yet another aspect of the disclosure there is provided a method of manufacturing a fastener comprising: forging the fastener in a die configured to produce a fastener comprising a shank and a non-circular-shaped head having a first axis xa and a second axis xb longer than and perpendicular to the first axis xa, wherein the die is configured to provide a die split line longitudinally aligned with the first axis xa to produce a correspondingly aligned seam extending along the shank and opposing sides of the head of the fastener; and, grinding said seam to remove remnant material from the fastener after removing the fastener from the die.

### BRIEF DESCRIPTION OF DRAWINGS

Embodiments of the disclosure will now be described by way of example with reference to the accompanying FIG.s in which:

FIG. 1A depicts a side view of a conventional prior art fastener;

FIG. 1B depicts a cross-section taken along line 1B-1B in FIG. 1A;

FIG. 2 depicts a cross-sectional side view of a conventional liner having a recess for receiving the fastener shown in FIGS. 1A and 1B;

FIG. 3A depicts the fastener in FIGS. 1A and 1B received within the recess of the conventional liner shown in FIG. 2;

FIG. 3B depicts a schematic, sectional end view of the prior art fastener installed in the conventional liner taken along line 3B-3B in FIG. 3A;

FIG. 3C depicts detail 3C from FIG. 3B;

FIG. 4A depicts a side view of a fastener in accordance with the present disclosure;

FIG. 4B depicts a cross-section taken along line 4B-4B in FIG. 4A;

FIG. 5A depicts the fastener in FIG. 4A installed within the recess of the conventional liner in FIG. 2;

FIG. 5B depicts a schematic, sectional end view of the fastener installed in the conventional liner taken along line 5B-5B in FIG. 5A;

FIG. 5C depicts detail 5C from FIG. 5B;

FIG. 6A depicts a side view of a die configured to manufacture the fastener in FIG. 4A;

FIG. 6B depicts an end view of the die of FIG. 6A; and

FIG. 7 depicts a flowchart illustrating the steps of a method of manufacturing a fastener.

### DETAILED DESCRIPTION

The present disclosure relates to a fastener configured to permit improved seating of the fastener in a wear surface liner.

Throughout this specification, unless specifically stated otherwise or the context requires otherwise, reference to a single step, composition of matter, group of steps or group of compositions of matter shall be taken to encompass one and a plurality (i.e. one or more of those steps, compositions of matter, groups of steps or groups of compositions of matter). Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

The term “and/or” e.g., “X and/or Y” shall be understood to mean either “X and Y” or “X or Y” and shall be taken to provide explicit support for both meanings or for either meaning.

Throughout this specification the word “comprise”, or such variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which the contents of the present disclosure belongs. Although methods and materials similar or equivalent to those described herein can be used in the practice or testing of the present disclosure, suitable methods and materials are described below. In case of conflict, the present specification, including definitions, will control. In addition, the materials, and examples are illustrative only and do not intend to be limiting.

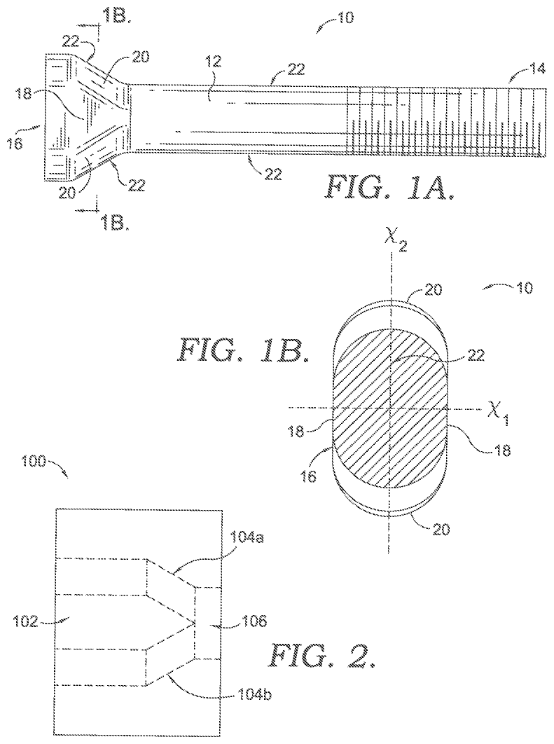

With reference FIGS. 1A to 3C, the prior art fastener 10 includes a shank 12 having a threaded portion 14 and a head 16 extending from the shank 12.

The head 16 has a generally oval cross-sectional shape having a first axis x1 and a second axis x2 longer than, and perpendicular to, the first axis x1. As used throughout this disclosure, the term oval refers to a shape having a first axis x1 and a second axis x2, wherein the longer edge of the head is flat, and the shorter edge of the head is rounded. The first axis x1 has a length generally corresponding to an outer diameter of the shank 12. The head 16 is defined by a pair of opposing flat surfaces 18 and a pair of opposing tapered curved surfaces 20 which taper towards the shank 12 at a predetermined taper angle.

The fastener 10 may be forged in a conventional die (not shown) comprising a pair of opposing halves. The opposing halves are configured such that a die split line therebetween is disposed in alignment with the second axis x2, in other words along a center line of the tapered curved surfaces 20. In this way, when the fastener 10 is forged, a seam 22 of residual material, for example metal, is disposed on the tapered curved surfaces 20 along second axis x2. The seam 22 may subsequently be removed from the fastener 10, for example by grinding, prior to use.

Grinding the seam 22 has the potential to create a grind mark (not shown) on the tapered curved surfaces 20 which can lead to stress failure of the fastener 10 and the emergence of stress related cracks along the tapered curved surfaces 20. Additionally, grinding may cause tapered curved surfaces 20 to become uneven or to alter the taper angle. This can lead to the fastener 10 incorrectly seating in the wear surface liner 100.

FIG. 2 depicts the wear surface liner 100 and defines a recess 102. The recess 102 defines tapered side walls 104a, 104b and a central through-hole 106.

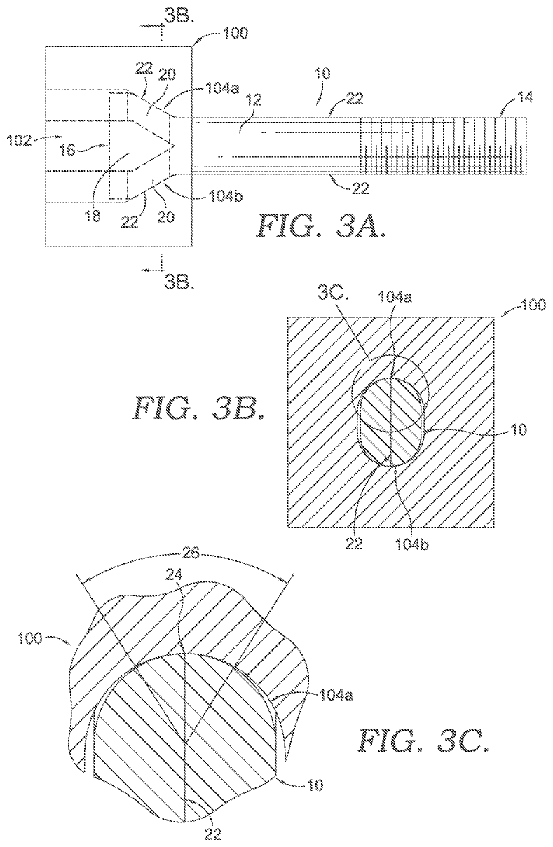

FIG. 3A depicts prior art fastener 10 installed within the recess 102 of the wear surface liner 100. The threaded portion 14 of the shank 12 is passed through through-hole 106 until tapered curved surfaces 20 of the head 16 abut the tapered side walls 104a, 104b. Accordingly, the seam 22 of fastener 10 also abuts the tapered side walls 104a, 104b of the wear surface liner 100.

FIGS. 3B and 3C illustrate the manner in which the head 16 of the fastener 10 is seated in the through-hole 106. When the fastener 10 is received in the through-hole 106 in the wear surface liner 100, the curved tapered surfaces 20 bear upon the tapered side walls 104a, 104b. In particular, a concentrated point of loading forces is present at an interface point 24 which is coincident with second axis x2.

FIG. 3C further depicts the location of the interface point 24 and shows that it is coincident with the seam 22. Additionally, in use, the fastener 10 creates an arc of contact 26 with the side walls 104 of the wear surface liner 100. The combination of the limited size of the arc of contact 26, concentrated loading forces at the interface point 24, and/or any alterations in the taper angle caused by grinding along the seam 22 can lead to failure and incorrect seating of fastener 10 in wear surface liner 100.

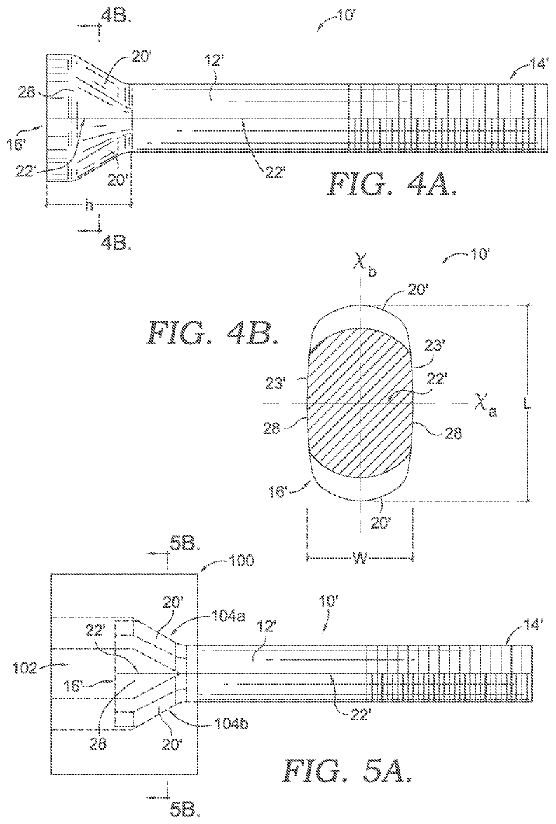

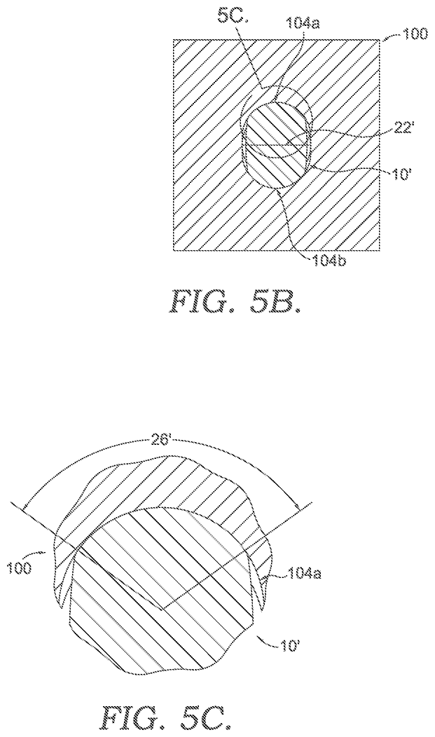

With reference now to FIGS. 4A to 5C, an improved fastener 10′ is shown, wherein like features are referred to with reference to like numerals throughout. The improved fastener 10′, according to one embodiment, includes a cylindrical shank 12′ having a threaded portion 14′ and a head 16′ extending from shank 12′. The improved fastener 10′ is generally constructed from steel, alloy, aluminum, chrome, brass or synthetic plastic. However, one of ordinary skill in the art would understand that this list is non-exhaustive, and that other materials are considered to be within the scope of this disclosure.

The head 16′ has a generally oblate cross-sectional shape having a first axis xₐ and a second axis x_{b} longer than, and perpendicular to, the first axis xₐ. The first axis xₐ has a length marginally greater than an outer diameter of the shank 12′. The head 16′ is defined by a pair of opposing arcuate surfaces 28 and a pair of opposing curved surfaces 20′ which taper towards the shank 12′ at a predetermined taper angle. It will be appreciated that other embodiments may have alternative shaped heads which are non-circular, such as rectangular, polygonal and so forth.

The head 16′ has a constant cross-sectional portion defined by opposing arcuate surfaces 28, and a tapered cross-sectional portion defined by tapered curved surface 20′. In accordance with aspects herein, the constant cross-sectional portion may be alternatively referred to as having a first cross-sectional area, and the outer diameter of the shank 12′ may alternatively be referred to as having a second cross-sectional area. The first cross-sectional area may generally be between 2 and 5 times the size of the second cross-sectional area, although other size differentials are considered to be within the scope of this disclosure. In accordance with aspects herein, the head 16′ is described as generally having a disco-rectangular cross-sectional shape which includes a width W, an overall length L, and two parallel length portions 23′. In some aspects, the two parallel length portions 23′ are shorter than the width W of the of the disco-rectangular cross-sectional shape, and in other aspects, the two parallel length portions 23′ are longer than the width W of the of the disco-rectangular cross-sectional shape. The disco-rectangular cross-sectional shape described herein is advantageous compared to standard cross-sectional shapes, inasmuch as the disco-rectangular shape provides a gap between the edges of a countersunk bore and the edges of the disco-rectangular shape. As such, a user of the disco-rectangular shape may be able to grip the edges of the disco-rectangular shape, with fingers or any other type of tool.

The improved fastener 10′ is forged in an improved die (discussed below) comprising a pair of opposing halves. The opposing halves are configured such that a die split line therebetween is disposed in alignment with the first axis xₐ, in other words along a centre line of the arcuate surfaces 28 of the head 10′. In this way, when the fastener 10′ is forged, a seam 22′ of residual metal is disposed on the shank 12′ and arcuate surfaces 28 in longitudinal alignment with first axis xₐ. Additionally, the disco-rectangular shape of the die is configured to allow for easy release of the fastener 10′ from the improved die.

Advantageously, although the seam 22′ may require grinding to remove residual material , such as metal, after forging the fastener 10′, the ability of the fastener 10′ to correctly seat in the wear surface liner 100 is not unduly affected. As the seam 22′, is away from the curved tapered surfaces 20′, no grinding of the curved tapered surfaces 20′ is required and the risk of altering the taper angle, introducing additional stresses or damaging the curved tapered surfaces 20′ during grinding is mitigated.

FIG. 5A depicts the improved fastener 10′ installed within recess 102 of the wear surface liner 100. The curved tapered surfaces 20′ abut the tapered side walls 104a, 104b of recess 102. Advantageously, the seam 22′ of fastener 10′ is disposed away from the tapered side walls 104a, 104b of the wear surface liner 100 and therefore does not interact with this critical contact face.

FIGS. 5B and 5C illustrate the manner in which the head 16′ of the fastener 10′ is seated in the recess 102. In contrast to the prior art fastener 10, there is a greater arc of contact 26′ between the head 16′ and the side walls 104a, 104b, thereby improving the seating of the head 16′ in the liner 100. The greater arc of contact 26′ may be attributed to the oblate cross-sectional shape of the head 16′ and the absence of the seam 22 at the interface point 24 along second axis xb where the head 16′ is subject to a concentrated point of loading forces. Advantageously, this minimises the potential for failure of the improved fastener 10′.

The improved arc of contact 26′ created by the improved fastener 10′, further provides a greater arc of contact 26′ with the side walls 104a, 104b in comparison to the arc of contact 26 created by the prior art fastener 10. The improved seating of the fastener 10′ in the liner 100 spreads the fastener load more evenly over the arc of contact 26′ which results in improved retention of the fastener 10′ in the liner 100. Additionally, as a result of the better seating, there is a higher probability of obtaining the appropriate securing force, and thus maintaining a higher fastener load. The generally disco-rectangular shape is advantageous over previous head bolt designs, as this head shape is easier to be gripped by a user when placed into a through hole. The advanced gripping properties are best exhibited by FIG. 5C, which depicts a space between the exterior of the bolt head and the corresponding hole.

In use, the wear surface liner 100 is secured to an interior of a grinding mill (not shown), by aligning the recess 102 of liner 100 with an aperture (not shown) of the grinding mill. The threaded portion 14′ of the shank 12′ is inserted through the recess 102 to extend through the aperture of the grinding mill. A nut (not shown) is then threadably engaged with the threaded portion 14′ of the fastener 10′. The wear surface liner 100 is clamped against the interior of the grinding mill by tightening the nuts on the threaded portion 14′ to seat the head 16′ against stop walls 104a and 104b.

The fastener 10′ is preferably forged from steel, but any other suitable material known in the art may be used. For example, fasteners 10′ may be forged from an alloy, aluminum, chrome, brass or synthetic plastics or a composite material. The fastener 10′ may be coloured in order to distinguish them from conventional fasteners, so that for example they can be easily identified in a tray of similar fasteners 10′. Different colours may also be used for different sized fasteners 10′ to indicate their different sizes.

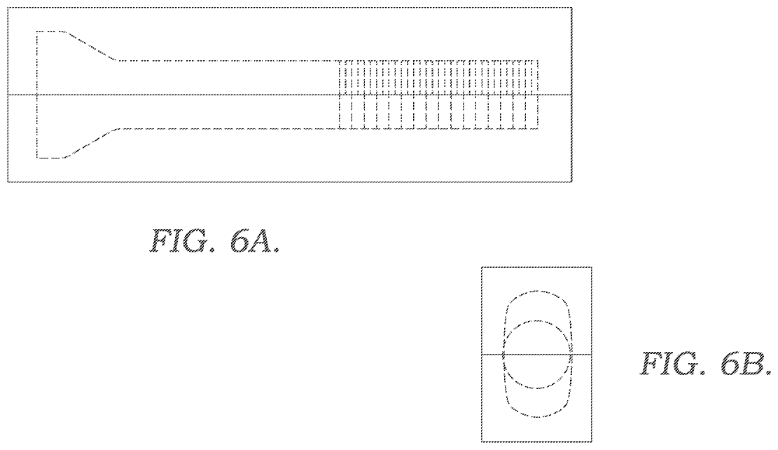

FIGS. 6A and 6B depict a die 200 configured to manufacture the improved fastener 10′. The die 200 generally comprises a head recess 202, wherein the head recess 200 has a constant cross-sectional portion 204 and a tapered cross-sectional portion 206. In accordance with aspects herein, the constant cross-sectional portion 204 and the tapered cross-sectional portion 206 have a generally disco-rectangular cross-sectional shape having a width W, an overall length L, and two parallel length portions 223. The die also comprises a body recess 210, wherein the body recess 210 comprises a non-threaded body portion 212 and a threaded body portion 214.

In accordance with aspects herein, the die 200 further comprises a first die portion 201a and a second die portion 201b. The first die portion 201a and the second die portion 201b create a die split line 203, at which the first die portion 201a and the second die portion 201b couple together. The die split line 203 bisects the two parallel length portions 223 of the generally disco-rectangular cross-sectional shape. Further, the tapered cross-sectional portion 206 tapers from a first cross-sectional area 208 a second cross-sectional area 210. As discussed herein, the first cross-sectional area may be between 2 and 5 times the size of the second cross-sectional area, although other sizes are considered to be within the scope of this disclosure. In other aspects, the head recess 202 is between one-eighth and one-half of the length of body recess 210. Further, the body recess 210 comprises the threaded body portion 214 having 4-10 threads per inch (TPI).

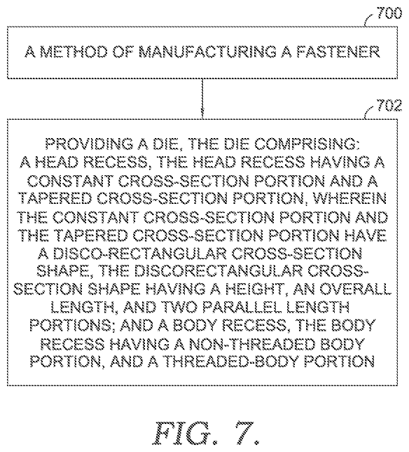

With reference now to FIG. 7, a method of manufacturing a fastener 300 is depicted. The method of manufacturing a fastener 700 includes step 702, which comprises providing a die. The die of step 702 further comprises a head recess and a body recess, as discussed with respect to FIGS. 6A and 6B. The head recess has a constant cross-section portion and a tapered cross-section portion, wherein the constant cross-section portion and the tapered cross-section portion have a disco-rectangular cross-sectional shape, the disco-rectangular cross-section shape having a height, an overall length, and two parallel length portions. The body recess has a non-threaded body portion, and a threaded-body portion. As one of ordinary skill in the art would readily understand, the typical manufacturing process involves filling the die with a liquid material, letting the liquid material cool, and then removing the part.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. For example, the axial length of the fastener 26 can be varied to suit the thickness of the wear surface liner 100. Preferably the threaded portion 14′ is provided with 6 threads per inch, however, this can be modified depending upon the clamping force required and different sized liners 100. In addition, the size of the head 14′ can be forged to correspond with the size of the recess 102 of the liner 100.

1. A fastener comprising:
a head having a constant cross-section portion and a tapered cross-section portion, wherein the constant cross-section portion and the tapered cross-section portion have a disco-rectangular cross-sectional shape, the disco-rectangular cross-sectional shape having a width, an overall length, and two parallel length portions; and
a non-threaded body portion, and a threaded body portion.

2. The fastener of claim 1, wherein the two parallel length portions are shorter than the width of the disco-rectangular cross-sectional shape.

3. The fastener of claim 1, wherein the two parallel length portions are longer than the width of the disco-rectangular cross-sectional shape.

4. The fastener of claim 3, wherein the tapered cross-section portion having the disco-rectangular shape tapers from a first cross-sectional area to a second cross- sectional area.

5. The fastener of claim 4, wherein the first cross-sectional area is between 2 to 5 times the size of the second cross-sectional area.

6. The fastener of claim 5, wherein the fastener is constructed from one of the following: steel, alloy, aluminum, chrome, brass, or synthetic plastic.

7. A die configured to form a fastener, the die comprising:
a head recess, the head recess having a constant cross-section portion and a tapered cross-section portion, wherein the constant cross-section portion and the tapered cross-section portion have a disco-rectangular cross-sectional shape, the disco-rectangular cross-sectional shape having a height, an overall length, and two parallel length portions; and
a body recess, the body recess having a non-threaded body portion, and a threaded-body portion.

8. The die of claim 7, wherein the die comprises a first die portion and a second die portion.

9. The die of claim 8, wherein the die comprises a die split line at which the first die portion and the second die portion couple together, and wherein the die split line bisects the two parallel length portions of the disco-rectangular cross-sectional shape.

10. The die of claim 9, wherein the tapered cross-section portion having the disco-rectangular shape tapers from a first cross-sectional area to a second cross-sectional area.

11. The die of claim 10, wherein the first cross-sectional area is between 2 to 5 times the size of the second cross-sectional area.

12. The die of claim 11, wherein the head recess is between one-eighth and one-half of the length of the body recess.

13. The die of claim 12, wherein the body recess having the threaded body portion comprises 4-10 threads per inch.

14. A method of manufacturing a fastener, the method comprising:
providing a die, the die comprising:
a head recess, the head recess having a constant cross-section portion and a tapered cross-section portion, wherein the constant cross-section portion and the tapered cross-section portion have a disco-rectangular cross-sectional shape, the disco-rectangular cross-section shape having a height, an overall length, and two parallel length portions; and
a body recess, the body recess having a non-threaded body portion, and a threaded-body portion.

15. The method of claim 14, wherein the die comprises a first die portion and a second die portion.

16. The method of claim 15, wherein the die comprises a die split line at which the first die portion and the second die portion couple together, and wherein the die split line bisects the two parallel length portions of the generally disco-rectangular cross-sectional shape.

17. The method of claim 16, wherein the tapered cross-section portion having the disco-rectangular shape tapers from a first cross-sectional area to a second cross- sectional area.

18. The method of claim 17, wherein the first cross-sectional area is between 2 to 5 times the size of the second cross-sectional area.

19. The method of claim 14 to 18, wherein the head recess is between one-eighth and one-half of the length of the body recess.

20. The method of claim 19, wherein the body recess having the threaded body portion comprises 4-10 threads per inch. Page 6 of 7 4863-0041-2440
